(19) United States
(12) Patent Application Publication
(10) Pub. No.: US 2025/0010611 A1
(43) Pub. Date: Jan. 9, 2025

(54) LIQUID EJECTING HEAD AND IMAGE FORMING APPARATUS

(71) Applicant: SEIKO EPSON CORPORATION, Tokyo (JP)

(72) Inventors: Shohei MIZUTA, MATSUMOTO-SHI (JP); Naoyuki OTA, SHIOJIRI-SHI (JP); Hidetoshi ISHII, MATSUMOTO-SHI (JP); Shuichi TANAKA, CHINO-SHI (JP)

(21) Appl. No.: 18/763,452

(22) Filed: Jul. 3, 2024

(30) Foreign Application Priority Data
Jul. 7, 2023 (JP) 2023-112213

(51) Int. Cl. B41J 2/14

(52) U.S. Cl. CPC B41J 2/14233; B41J 2202/11; B41J 2202/12

(57) ABSTRACT

A liquid ejecting head includes a pressure chamber substrate forming a pressure chamber in which an liquid is stored, a flow path forming substrate forming a flow path through which the liquid flows, a pressure portion applying a pressure to the liquid in the pressure chamber, and a diaphragm bonded to the pressure portion and vibrating with displacement of the pressure portion, in which the pressure chamber substrate is bonded to the flow path forming substrate with an adhesive and has inclined portions each having one or more inclined surfaces that are inclined with respect to a normal direction of a surface of the diaphragm in such a way that a width of the pressure chamber decreases toward the diaphragm.

The present application is based on, and claims priority from JP Application Serial Number 2023-112213, filed Jul. 7, 2023, the disclosure of which is hereby incorporated by reference herein in its entirety.

### BACKGROUND

### 1. Technical Field

The present disclosure relates to a liquid ejecting head and an image forming apparatus.

### 2. Related Art

An image forming apparatus that includes a liquid ejecting head that ejects a liquid such as ink onto a medium such as printing paper has been proposed. In recent years, the image forming apparatus has attracted attention not only for printing purposes but also as an apparatus that can apply a liquefiable material to an arbitrary location. As the liquid ejecting head included in the image forming apparatus, a head is known that ejects a liquid filled in a pressure chamber from a nozzle by vibrating a diaphragm forming a wall surface of the pressure chamber using a piezoelectric element.

A liquid ejecting head described in JP-A-2014-172328 includes an actuator substrate and a holding substrate bonded to the actuator substrate with an adhesive. The actuator substrate includes a flow path forming portion, the diaphragm, the piezoelectric element, and a bonded portion. The flow path forming portion includes a liquid chamber. The diaphragm forms one wall surface of the liquid chamber. The piezoelectric element is disposed on the opposite side of the diaphragm from the liquid chamber. The bonded portion is a portion that is bonded to the holding substrate with the adhesive.

When coupling the bonded portion and the holding substrate using the adhesive, the excess softened adhesive may flow out of the bonded portion and reach the diaphragm. When the adhesive is hardened on the diaphragm, there is a problem that the hardened adhesive hinders displacement of the diaphragm, which causes inconsistency in ink ejection. In JP-A-2014-172328, the adhesive is blocked by providing a protruding structure near the bonded portion.

However, in the related art, a step formed by the protruding structure is parallel to a vertical direction. Therefore, the adhesive tends to flow downward in the vertical direction. Therefore, there is a need for further measures to suppress the adhesive from flowing onto the diaphragm.

### SUMMARY

According to an aspect of the present disclosure, a liquid ejecting head includes: a pressure chamber substrate forming a pressure chamber in which an liquid is stored; a flow path forming substrate forming a flow path through which the liquid flows; a pressure portion applying a pressure to the liquid in the pressure chamber; and a diaphragm bonded to the pressure portion and vibrating with displacement of the pressure portion, in which the pressure chamber substrate is bonded to the flow path forming substrate with an adhesive and has inclined portions each having one or more inclined surfaces that are inclined with respect to a normal direction of a surface of the diaphragm in such a way that a width of the pressure chamber decreases toward the diaphragm.

### BRIEF DESCRIPTION OF THE DRAWINGS

FIG. 1 is a schematic view illustrating a configuration of an image forming apparatus according to a first embodiment.

FIG. 2 is an exploded perspective view of a liquid ejecting head illustrated in FIG. 1.

FIG. 3 is a cross-sectional view of a part of the liquid ejecting head illustrated in FIG. 1.

FIG. 4 is an enlarged view of a part of the liquid ejecting head in FIG. 3.

FIG. 5 is an enlarged view of a part of the liquid ejecting head in FIG. 3.

FIG. 6 is a perspective view illustrating a part of a pressure chamber substrate in FIG. 5.

FIG. 7 is a view for describing bonding between the pressure chamber substrate and a flow path forming substrate.

FIG. 8 is a view for describing bonding between the pressure chamber substrate and the flow path forming substrate.

FIG. 9 is a view for describing a flow of the adhesive in a comparative example.

FIG. 10 is a view for describing a flow of an adhesive in the present embodiment.

FIG. 11 is an enlarged view of an inclined portion in FIG. 5.

FIG. 12 is a view for describing a flow of the adhesive on the inclined portion in FIG. 11.

FIG. 13 is a view illustrating an inclined portion of a second embodiment.

FIG. 14 is a view for describing a flow of an adhesive in the second embodiment.

FIG. 15 is a view for describing another example of a flow of the adhesive in the second embodiment.

FIG. 16 is a view illustrating an inclined portion of a modified example.

FIG. 17 is a view illustrating an inclined portion of another modified example.

FIG. 18 is a view for describing bonding between a pressure chamber substrate and a flow path forming substrate.

### DESCRIPTION OF EMBODIMENTS

Hereinafter, exemplary embodiments according to the present disclosure will be described with reference to the accompanying drawings. Note that the dimensions or the scale of each component may differ appropriately from actual dimensions or scales, and some portions are schematically illustrated in the drawings to facilitate understanding. Further, the scope of the present disclosure is not limited to the embodiments unless otherwise specified in the following description. Furthermore, the phrase “an element β on an element γ” is not limited to a configuration in which the element γ and the element β are in direct contact with each other, but also includes a configuration in which the element γ and the element β are not in direct contact with each other. The phrase “the element γ and the element β are the same” means that the element γ and the element β are substantially the same as each other, and includes manufacturing errors and the like.

### 1. First Embodiment

### 1-1. Overall Configuration of Image Forming Apparatus 100

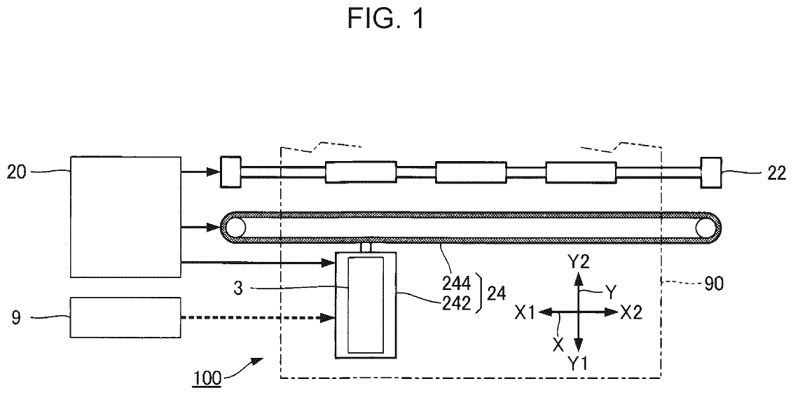

FIG. 1 is a schematic view illustrating a configuration of an image forming apparatus 100 according to a first embodiment. In the following, for convenience of explanation, an X axis, a Y axis, and a Z axis that are orthogonal to one another are used as appropriate. Further, a direction along the X axis is referred to as an X1 direction, and a direction opposite to the X1 direction is referred to as an X2 direction. Similarly, a direction along the Y axis is referred to as a Y1 direction, and a direction opposite to the Y1 direction is referred to as a Y2 direction. A direction along the Z axis is referred to as a Z1 direction, and a direction opposite to the Z1 direction is referred to as a Z2 direction.

The image forming apparatus 100 in FIG. 1 is an ink jet printing apparatus that ejects ink, which is an example of a liquid, onto a medium 90. The medium 90 is typically printing paper, and may be a printing target made of any material such as a resin film or cloth. As illustrated in FIG. 1, a liquid container 9 that stores the ink is installed in the image forming apparatus 100. For example, a cartridge that is detachably attached to the image forming apparatus 100, a bag-shaped ink pack made of a flexible film, or an ink tank that can be refilled with the ink is used as the liquid container 9.

The image forming apparatus 100 includes a control unit 20, a medium transport mechanism 22, a movement mechanism 24, and a liquid ejecting head 3. The control unit 20 includes, for example, one or more processing circuits such as a central processing unit (CPU) or a field programmable gate array (FPGA), and one or more storage circuits such as a semiconductor memory, and comprehensively controls each element of the image forming apparatus 100. The medium transport mechanism 22 transports the medium 90 in the direction along the Y axis under the control of the control unit 20. Further, the movement mechanism 24 reciprocates the liquid ejecting head 3 along the X axis under the control of the control unit 20. The movement mechanism 24 includes a substantially box-shaped transport body 242 that accommodates the liquid ejecting head 3, and a transport belt 244 to which the transport body 242 is fixed. A configuration in which a plurality of liquid ejecting heads 3 are mounted on the transport body 242, or a configuration in which the liquid container 9 is mounted on the transport body 242 together with the liquid ejecting head 3 can also be adopted.

The liquid ejecting head 3 ejects the ink supplied from the liquid container 9 onto the medium 90 from a plurality of nozzles under the control of the control unit 20. An image is formed on the surface of the medium 90 when each liquid ejecting head 3 ejects the ink onto the medium 90 in parallel with the transport of the medium 90 by the medium transport mechanism 22 and the repeated reciprocation of the transport body 242.

Such an image forming apparatus 100 includes the liquid ejecting head 3 having characteristics described below. Therefore, deterioration in printing quality can be suppressed.

### 1-2. Overall Configuration of Liquid Ejecting Head 3

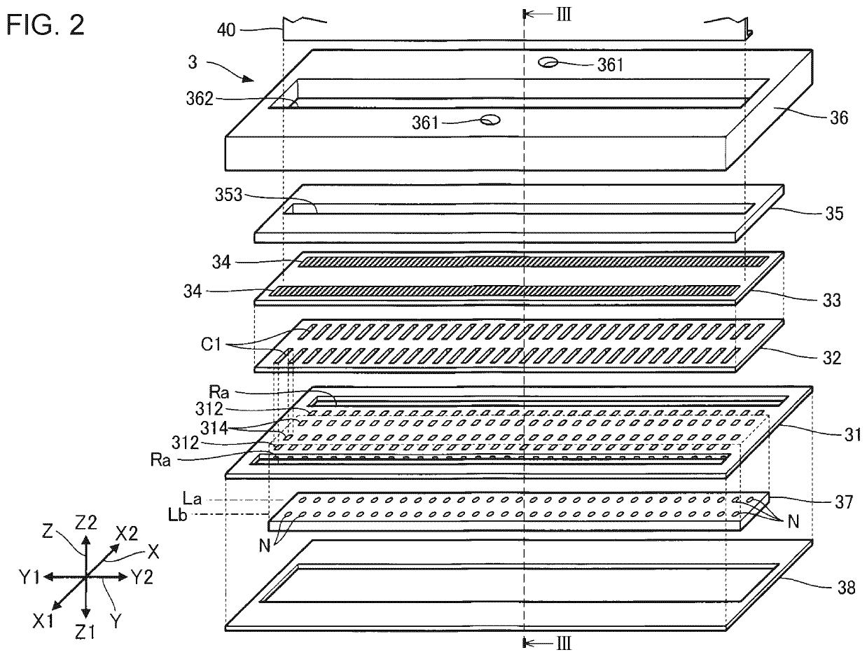

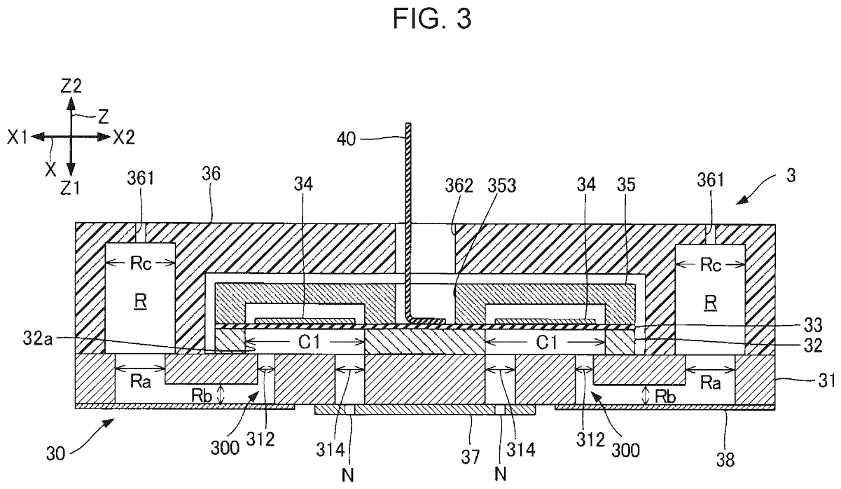

FIG. 2 is an exploded perspective view of the liquid ejecting head 3 illustrated in FIG. 1. FIG. 3 is a cross-sectional view of a part of the liquid ejecting head illustrated in FIG. 1, and is a cross-sectional view taken along line III-III of FIG. 2. The cross section illustrated in FIG. 3 is parallel to an X-Z plane. The Z axis is an axis along an ink ejection direction of the liquid ejecting head 3. A “first direction” intersecting the Z2 direction is, for example, a direction along the X axis, and is the X1 direction or the X2 direction.

As illustrated in FIG. 2, the liquid ejecting head 3 includes a plurality of nozzles N arranged along the Y axis. The plurality of nozzles N of the first embodiment are divided into a first row La and a second row Lb that are arranged in parallel along the X axis at an interval. Each of the first row La and the second row Lb is a set of the plurality of nozzles N arranged linearly along the Y axis. The liquid ejecting head 3 has a structure in which elements related to each nozzle N of the first row La and elements related to each nozzle N of the second row Lb are arranged substantially symmetrically. In the following description, elements corresponding to the first row La will be mainly described, and a description of elements corresponding to the second row Lb will be omitted as appropriate.

As illustrated in FIGS. 2 and 3, the liquid ejecting head 3 includes a flow path forming substrate 31, a pressure chamber substrate 32, a diaphragm 33, a nozzle plate 37, a vibration absorber 38, a plurality of pressure portions 34, a sealing body 35, a housing portion 36, and a wiring substrate 40. Each of the flow path forming substrate 31, the pressure chamber substrate 32, the diaphragm 33, the nozzle plate 37, the vibration absorber 38, the sealing body 35, and the housing portion 36 is an elongated plate-shaped member along the Y axis. Further, the nozzle plate 37, the flow path forming substrate 31, the pressure chamber substrate 32, the diaphragm 33, and the sealing body 35 are arranged in this order in the Z2 direction.

The nozzle plate 37 is a plate-shaped member in which the plurality of nozzles N are formed. Each of the plurality of nozzles N is a circular through-hole through which the ink is ejected. The nozzle plate 37 is bonded to a surface of the flow path forming substrate 31 in the Z1 direction with, for example, an adhesive.

The flow path forming substrate 31 forms a flow path through which the ink flows. Specifically, a space Ra, an intermediate liquid chamber Rb, a plurality of supply flow paths 312, and a plurality of communicating flow paths 314 are formed in the flow path forming substrate 31. The space Ra is an elongated opening along the Y axis. Each of the supply flow paths 312 and the communicating flow paths 314 is a through-hole formed for each nozzle N. Each communicating flow path 314 overlaps one corresponding nozzle N in plan view when viewed from the Z1 direction. The intermediate liquid chamber Rb is a space formed in an elongated shape along the Y axis across the plurality of nozzles N, and allows the space Ra and the plurality of supply flow paths 312 to communicate with each other. The pressure chamber substrate 32 is bonded to a surface of the flow path forming substrate 31 in the Z2 direction with an adhesive.

A plurality of pressure chambers C1 are formed in the pressure chamber substrate 32. The ink ejected from the nozzle N is stored in the pressure chamber C1. The pressure chamber C1 is a space positioned between the nozzle plate 37 and the diaphragm 33 and formed by an inner wall surface 32a of the pressure chamber substrate 32. The pressure chamber C1 is formed for each nozzle N. The pressure chamber C1 is an elongated space and extends in the X1 direction. The plurality of pressure chambers C1 are arranged along the Y axis. Each pressure chamber C1 communicates with the communicating flow path 314 and the supply flow path 312. Therefore, the pressure chamber C1 communicates with the nozzle N through the communicating flow path 314 and communicates with the space Ra through the supply flow path 312 and the intermediate liquid chamber Rb.

The nozzle plate 37, the flow path forming substrate 31, and the pressure chamber substrate 32 are manufactured by processing a silicon (Si) single crystal substrate using semiconductor manufacturing techniques such as photolithography and etching. However, any known materials and manufacturing methods may be used to manufacture the nozzle plate 37, the flow path forming substrate 31, and the pressure chamber substrate 32.

The diaphragm 33 is coupled to a surface of the pressure chamber substrate 32 that is opposite to the flow path forming substrate 31. The diaphragm 33 is disposed above the pressure chamber C1 and is elastically deformable. The diaphragm 33 is a plate-shaped member formed in an elongated rectangular shape along the Y axis in plan view. The diaphragm 33 and the pressure chamber may be configured integrally, or may be configured separately and bonded with an adhesive or the like.

The pressure portion 34 is formed on a surface of the diaphragm 33 that is opposite to the pressure chamber C1. The pressure portion 34 is provided for each pressure chamber C1. The pressure portion 34 has an elongated shape along the X axis in plan view. The pressure portion 34 is a piezoelectric element that applies a pressure to the ink in the pressure chamber C1. The pressure portion 34 is also a drive element that is driven by application of a drive signal.

The sealing body 35 is bonded to the diaphragm 33 with, for example, an adhesive. The sealing body 35 is a structure that protects the plurality of pressure portions 34 and reinforces mechanical strengths of the pressure chamber substrate 32 and the diaphragm 33. A recess is formed in a surface of the sealing body 35 that faces the diaphragm 33. The plurality of pressure portions 34 are accommodated inside the recess. Furthermore, the sealing body 35 has a space 353 through which the wiring substrate 40 is inserted.

The housing portion 36 is bonded to the flow path forming substrate 31 with, for example, an adhesive. The housing portion 36 is a case for storing the ink to be supplied to the plurality of pressure chambers C1. The housing portion 36 is formed, for example, by injection molding of a resin material. A space Rc, a supply port 361, and a space 362 are formed in the housing portion 36. The supply port 361 is a conduit through which the ink is supplied from the liquid container 9, and communicates with the space Rc. The space Rc communicates with the space Ra of the flow path forming substrate 31. A space formed with the space Ra and the space Rc functions as a liquid storing chamber R in which the ink to be supplied to the plurality of pressure chambers C1 is stored. The ink supplied from the liquid container 9 and passing through the supply port 361 is stored in the liquid storing chamber R. The ink stored in the liquid storing chamber R branches from the intermediate liquid chamber Rb to each supply flow path 312 and is supplied to the plurality of pressure chambers C1 in parallel. Further, the space 362 overlaps with the space 353 of the sealing body 35 in plan view. The wiring substrate 40 is inserted into the space 353 and the space 362.

The wiring substrate 40 is coupled to the diaphragm 33. The wiring substrate 40 is a mounted component on which a plurality of wirings for electrically coupling the control unit 20 and the liquid ejecting head 3 are formed. For example, the flexible wiring substrate 40 such as a flexible printed circuit (FPC) or a flexible flat cable (FFC) may be adopted as appropriate. The drive signal and a reference voltage for driving the pressure portion 34 are supplied from the wiring substrate 40 to each pressure portion 34.

The vibration absorber 38 is bonded to the surface of the flow path forming substrate 31 in the Z1 direction with, for example, an adhesive. The vibration absorber 38 is a flexible film forming a wall surface of the space Ra, and absorbs variation in pressure of the ink in the liquid storing chamber R.

### 1-3. Specific Configuration of Part of Liquid Ejecting Head 3

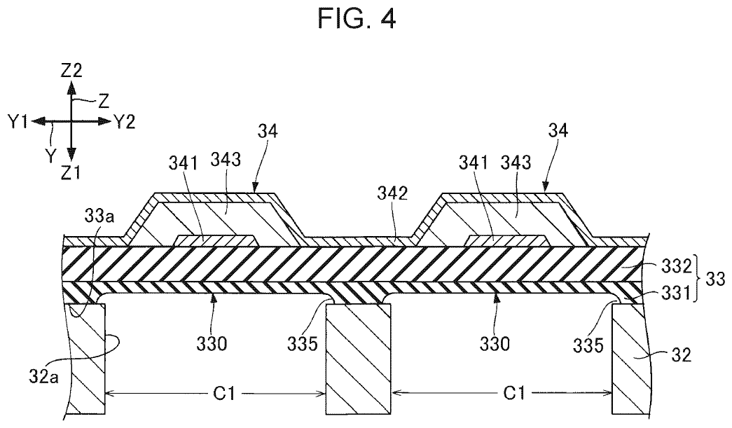

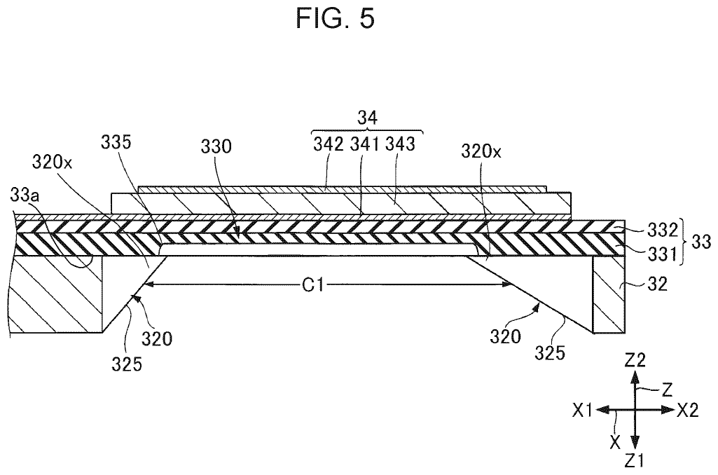

Each of FIGS. 4 and 5 is an enlarged view of a part of the liquid ejecting head 3 in FIG. 3. The cross section illustrated in FIG. 4 is parallel to a Y-Z plane. The cross section illustrated in FIG. 5 is parallel to the X-Z plane.

As illustrated in FIGS. 4 and 5, the pressure portion 34 is roughly a structure in which a first electrode 341, a piezoelectric body 343, and a second electrode 342 are stacked in this order from a diaphragm 33 side. The first electrode 341 and the second electrode 342 have different potentials.

The first electrode 341 is formed on the surface of the diaphragm 33. The first electrode 341 is provided for each pressure portion 34, and the first electrodes 341 are individual electrodes formed at intervals. A drive signal whose voltage varies is applied to the first electrode 341. The first electrode 341 has an elongated shape along the X axis. The plurality of first electrodes 341 are arranged along the Y axis at intervals. The first electrode 341 is made of a conductive material such as platinum (Pt) or iridium (Ir).

The piezoelectric body 343 is provided on the first electrode 341. The piezoelectric body 343 is, for example, a band-shaped dielectric film that extends along the Y axis across the plurality of pressure portions 34. The piezoelectric body 343 has, for example, a band shape extending along the Y axis, and a plurality of notches are formed in such a way that the piezoelectric body 343 is separated for each pressure portion 34. The piezoelectric body 343 is made of a known piezoelectric material such as lead zirconate titanate (Pb(Zr, Ti)O₃).

The second electrode 342 is provided on the piezoelectric body 343. The second electrode 342 is a band-shaped common electrode that continuously extends along the Y axis across the plurality of pressure portions 34. A predetermined reference voltage is applied to the second electrode 342. The second electrode 342 is made of a low resistance conductive material such as platinum or iridium.

A voltage corresponding to a difference between the reference voltage applied to the second electrode 342 and a drive signal corresponding to an ejection amount supplied to the first electrode 341 is applied to the piezoelectric body 343. The piezoelectric body 343 is deformed by applying a voltage between the first electrode 341 and the second electrode 342. As the piezoelectric body 343 is deformed, the pressure portion 34 bends and deforms the diaphragm 33, that is, vibrates the diaphragm 33. As the diaphragm 33 vibrates, a pressure in the pressure chamber C1 changes, and the ink in the pressure chamber C1 is ejected from the nozzle N.

The diaphragm 33 vibrates when the pressure portion 34 is driven. In the illustrated example, the diaphragm 33 is implemented by a laminate including a first layer 331 and a second layer 332. The first layer 331 is in contact with the pressure chamber substrate 32. The first layer 331 is made of an elastic material such as silicon dioxide (SiO₂). The second layer 332 is made of an insulating material such as zirconium dioxide (Zro₂). The first layer 331 is formed, for example, by thermally oxidizing a part of the pressure chamber substrate 32. The second layer 332 is formed, for example, by a known film forming technique such as sputtering. The diaphragm 33 may have a single-layer structure, or may have a structure including three or more layers.

A recessed portion 330 is provided on a side of the diaphragm 33 that faces the pressure chamber substrate 32. The recessed portion 330 is a recess formed by removing a part of the diaphragm 33. In the illustrated example, the recessed portion 330 is provided in the first layer 331. The recessed portion 330 does not penetrate through the first layer 331. However, the recessed portion 330 may penetrate through the first layer 331. In this case, a bottom surface of the recessed portion 330 is formed by the second layer 332. Further, a part of the recessed portion 330 may be formed by removing a part of the second layer 332.

The recessed portion 330 has a recess portion 335 at a portion bonded to the pressure chamber substrate 32. The recess portion 335 corresponds to an outer peripheral portion of the recessed portion 330 and is provided over the entire periphery of the recessed portion 330 in plan view. As described below, the recess portion 335 has a portion that overlaps an inclined portion 320 of the pressure chamber substrate 32 in plan view. Therefore, the recess portion 335 includes a recess portion that is recessed in the X1 direction and a recess that is recessed in the X2 direction.

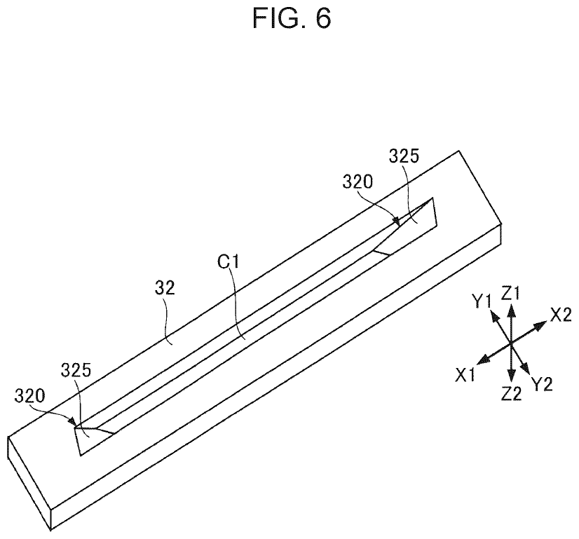

FIG. 6 is a perspective view illustrating a part of the pressure chamber substrate 32 in FIG. 5. As illustrated in FIGS. 5 and 6, the pressure chamber substrate 32 has two inclined portions 320. The inclined portions 320 are provided at both ends of the pressure chamber C1 in the direction along the X axis. Further, the inclined portion 320 is provided at a portion of the pressure chamber substrate 32 that is bonded to the diaphragm 33.

Each inclined portion 320 has an inclined surface 325. The inclined surface 325 is a flat surface, and is inclined with respect to a normal line A1 of a surface 33a of the diaphragm 33. Further, the inclined surface 325 is inclined in such a way that a width of the pressure chamber C1 decreases toward the diaphragm 33 in the Z2 direction.

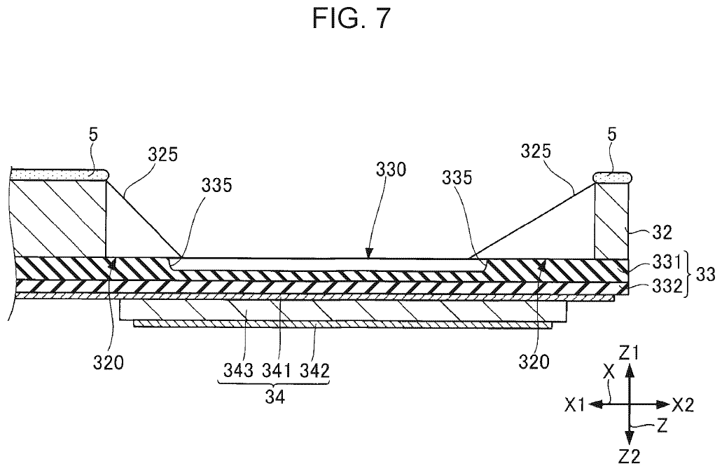

FIGS. 7 and 8 are views for describing bonding between the pressure chamber substrate 32 and the flow path forming substrate 31. As illustrated in FIG. 7, first, an adhesive 5 is applied onto a surface of the pressure chamber substrate 32 that is opposite to the diaphragm 33. The adhesive 5 is a thermosetting resin. Therefore, the adhesive 5 has fluidity before being hardened. Therefore, when the adhesive 5 is applied onto the surface of the pressure chamber substrate 32 that is opposite to the diaphragm 33, the adhesive 5 may flow down from the opposite surface vertically downward, that is, in the Z2 direction. The Z2 direction corresponds to the vertically downward direction when the adhesive 5 is applied.

As illustrated in FIG. 8, after the adhesive 5 is applied onto the pressure chamber substrate 32, the flow path forming substrate 31 is disposed on the pressure chamber substrate 32. Note that the pressure chamber substrate 32 may be disposed on the flow path forming substrate 31. Then, the adhesive 5 is hardened. As a result, the pressure chamber substrate 32 and the flow path forming substrate 31 are bonded to each other with the adhesive 5.

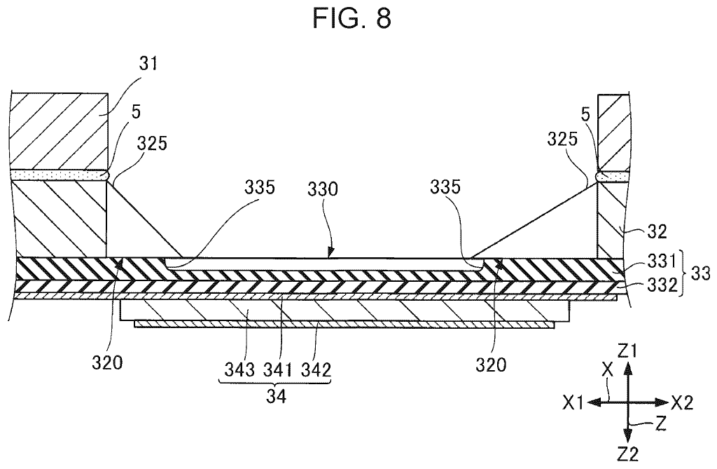

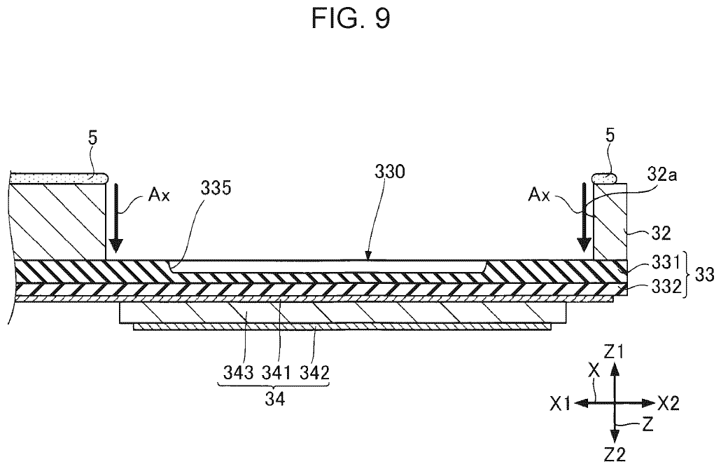

FIG. 9 is a view for describing a flow of the adhesive 5 in a comparative example. In the comparative example of FIG. 9, a case where the pressure chamber substrate 32 does not have the inclined surface 325, and the inner wall surface 32a of the pressure chamber substrate 32 that forms the pressure chamber C1 is along a vertical axis, that is, the inner wall surface is along the Z2 direction is considered. In this case, the excess adhesive 5 applied onto the surface of the pressure chamber substrate 32 that is opposite to the diaphragm 33 tends to flow in the Z2 direction along the inner wall surface 32a of the pressure chamber substrate 32. Therefore, the adhesive 5 tends to flow in the Z2 direction as indicated by an arrow Ax.

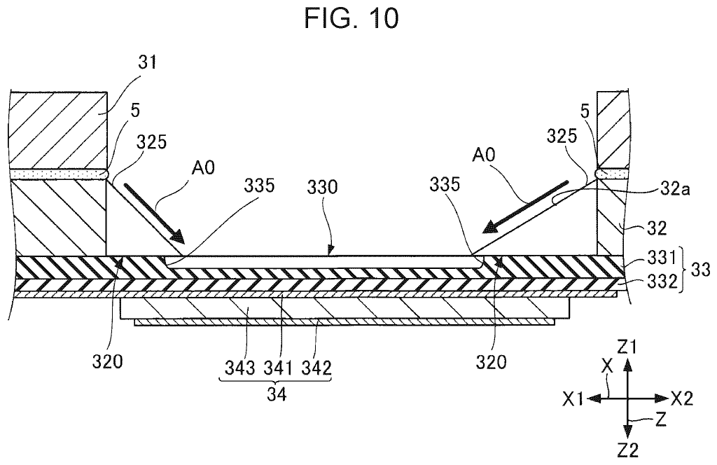

When the adhesive 5 flows on the inner wall surface 32a and reaches the diaphragm 33, the adhesive 5 may inhibit displacement of the diaphragm 33, causing inconsistency in vibration characteristic. As a result, there is a possibility that inconsistency in ejection characteristic occurs, which may cause deterioration in printing quality. FIG. 10 is a view for describing a flow of the adhesive 5 in the present embodiment. In the present embodiment of FIG. 10, the pressure chamber substrate 32 includes the inclined portion 320 having the inclined surface 325. From another perspective, the inner wall surface 32a of the pressure chamber substrate 32 has the inclined surface 325. The inclined surface 325 is inclined with respect to the 22 direction in such a way that the width of the pressure chamber C1 decreases toward the diaphragm 33 in the Z2 direction. Therefore, the excess adhesive 5 applied onto the surface of the pressure chamber substrate 32 that is opposite to the diaphragm 33 flows on the inclined surface 325. Therefore, the adhesive 5 flows as indicated by an arrow A0. As the inclined surface 325 is provided, it is possible to further suppress the adhesive 5 from flowing onto the diaphragm 33, compared to a case where the inclined surface 325 is not provided. Therefore, it is possible to suppress the adhesive 5 from flowing onto the diaphragm 33 with a simpler configuration than the configuration according to the related art.

The presence of the inclined surface 325 makes it possible to suppress the adhesive 5 from flowing onto the diaphragm 33, thereby preventing inconsistency in vibration characteristics of the diaphragm 33 due to the presence of the adhesive 5. Therefore, inconsistency in ejection characteristic can be suppressed. As a result, deterioration in printing quality can be suppressed.

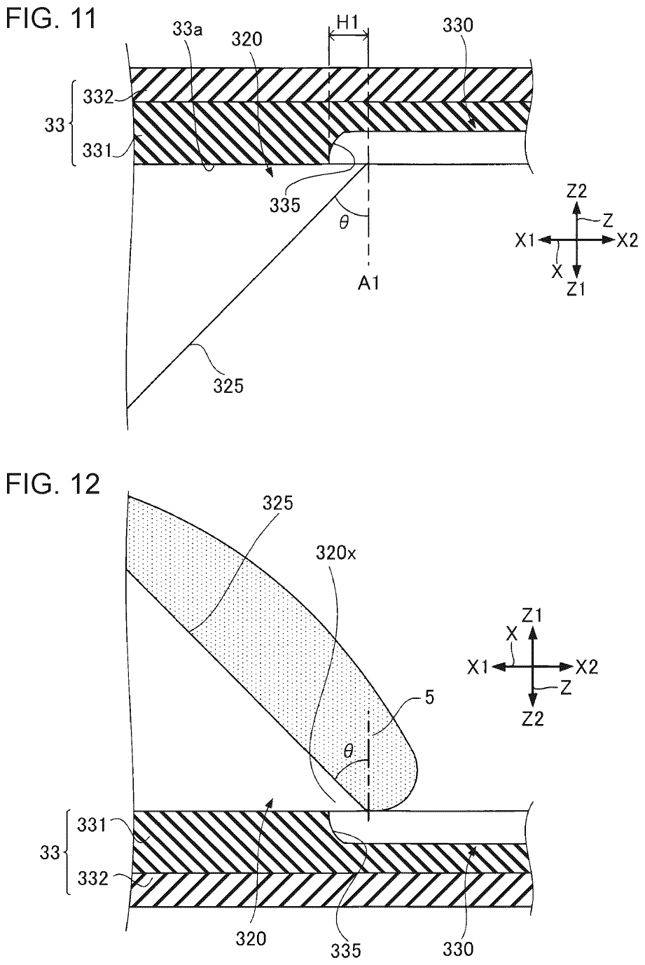

FIG. 11 is an enlarged view of the inclined portion 320 in FIG. 5. As illustrated in FIG. 11, the inclined surface 325 is inclined with respect to the Z2 direction, which is a normal direction of the surface 33a of the diaphragm 33. That is, the inclined surface 325 is inclined with respect to the normal line A1 of the surface 33a of the diaphragm 33. An inclination angle of the inclined surface 325 with respect to the normal line A1 is not particularly limited, and may be larger than 0 degrees and equal to or smaller than 45 degrees. When the inclination angle is equal to or smaller than 45 degrees, the gravity of the adhesive 5 in a direction in which the adhesive 5 flows out becomes ½ or less. Therefore, when the angle is within such a range, it is possible to more effectively suppress the adhesive 5 from flowing onto the diaphragm 33 than when the angle is outside the range.

In the present embodiment, the pressure chamber substrate 32 has two inclined portions 320 for each pressure chamber C1. The inclined surfaces 325 of the two inclined portions 320 may have the same or different inclination angles θ.

Further, the inclined portion 320 is provided at the portion of the pressure chamber substrate 32 that is bonded to the diaphragm 33. In addition, the inclined surface 325 is provided from the surface of the pressure chamber substrate 32 that is opposite to the diaphragm 33 to the portion bonded to the diaphragm 33. Therefore, it is possible to further suppress the adhesive 5 from flowing onto the diaphragm 33 as compared to a case where the inclined surface 325 is provided only in the middle of the pressure chamber substrate 32 in the Z2 direction.

FIG. 12 is a view for describing a flow of the adhesive 5 on the inclined portion 320 in FIG. 11. As described above, the diaphragm 33 has the recessed portion 330, and the inclined portion 320 overlaps the recess portion 335 of the recessed portion 330 in plan view of the diaphragm 33. In other words, when viewing the diaphragm 33 in the Z2 direction, the inclined portion 320 and the recess portion 335 appear to overlap each other in the X and Y directions. As illustrated in FIG. 12, as the recess portion 335 is provided, the adhesive 5 tends to stay at a distal end portion 320x of the inclined portion 320 due to surface tension. Therefore, it is possible to suppress the adhesive 5 from flowing onto the diaphragm 33.

The recess portion 335 may overlap the inclined portion 320 in a range of 50 nm or more and 2000 nm or less, and may overlap in a range of 50 nm or more and 1000 nm or less in plan view of the diaphragm 33. The overlap range is indicated by H1 in FIG. 11. When the overlap range is less than 50 nm, there is a higher possibility that the adhesive 5 does not stay at the distal end portion 320x and enters the recess portion 335, compared to when the overlap range is 50 nm or more. Further, when the overlap range is 2000 nm or less, the recess portion 335 can be easily formed even when the diaphragm 33 and the pressure chamber substrate 32 are integrated. From this point of view, the overlap range may be 1000 nm or less. Note that the overlap range is not limited to the above range.

Further, as illustrated in FIG. 5, the inclined portion 320 overlaps the pressure portion 34 in plan view of the diaphragm 33. In particular, the inclined portion 320 overlaps the piezoelectric body 343 in plan view. Since the distal end portion 320x of the inclined portion 320 has low rigidity, there is a possibility that the distal end portion 320x may break due to strain of the diaphragm 33. Therefore, the inclined portion 320 overlaps the pressure portion 34 in plan view, and it is thus possible to suppress the distal end portion 320x of the inclined portion 320 from breaking. The inclined portion 320 may be positioned to overlap a portion of the piezoelectric body 343 that is interposed between the first electrode 341 and the second electrode 342 in plan view. A possibility that the distal end portion 320x breaks can be further reduced. Note that the inclined portion 320 does not have to overlap the pressure portion 34.

In the present embodiment, the pressure chamber substrate 32 does not have the inclined portion 320 in a transverse direction of the pressure chamber C1 as illustrated in FIG. 4. However, the pressure chamber substrate 32 may have the inclined portion 320 in the transverse direction of the pressure chamber C1. Therefore, the inclined surface 325 of the inclined portion 320 may be provided over the entire periphery of the inner wall surface of the pressure chamber substrate 32 that forms the pressure chamber C1. By providing the inclined surface 325 over the entire periphery, it is possible to particularly effectively suppress the adhesive 5 from flowing onto the diaphragm 33.

Further, even when the pressure chamber substrate 32 does not have the inclined portion 320 in the transverse direction of the pressure chamber C1 as in the present embodiment, the provision of the recess portion 335 allows suppression of a flow of the adhesive 5 onto the diaphragm 33. The presence of the recess portion 335 in the transverse direction of the pressure chamber C1 allows the adhesive 5 to stay at a distal end portion of the pressure chamber substrate 32 that overlaps the recess portion 335 in plan view due to surface tension. Therefore, it is possible to further suppress the adhesive 5 from flowing onto the diaphragm 33, compared to a case where the recess portion 335 is not provided.

### 2. Second Embodiment

A second embodiment will be described. The reference numerals used in the description of the first embodiment are used for the elements having the same actions or functions as those of the first embodiment in the embodiment exemplified below, and a detailed description of each element is appropriately omitted.

FIG. 13 is a view illustrating an inclined portion 320A of the second embodiment. The inclined portion 320A illustrated in FIG. 13 is different from the inclined portion 320 of the first embodiment in that the inclined portion 320A has a plurality of inclined surfaces.

The inclined portion 320A has a first inclined surface 321, a second inclined surface 322, and a horizontal surface 323. The first inclined surface 321 and the second inclined surface 322 are inclined with respect to a normal line A1. The second inclined surface 322 is provided closer to a diaphragm 33 in a Z2 direction than the first inclined surface 321. The horizontal surface 323 couples the first inclined surface 321 and the second inclined surface 322. The horizontal surface 323 is orthogonal to the Z2 direction.

The first inclined surface 321 is inclined at a first inclination angle θ1 that is an inclination angle with respect to the normal line A1. The second inclined surface 322 is inclined at a second inclination angle θ2 that is an inclination angle with respect to the normal line A1. The first inclination angle θ1 and the second inclination angle θ2 are different from each other. Therefore, the inclined portion 320A has a plurality of inclined surfaces having different inclination angles. By providing a plurality of inclined surfaces with different inclination angles, it is possible to further suppress an adhesive 5 from flowing onto the diaphragm 33 as compared to the first embodiment.

In particular, the second inclination angle θ2 is larger than the first inclination angle θ1. Therefore, the inclination of the second inclined surface 322 closer to the diaphragm 33 is gentler than that of the first inclined surface 321. Therefore, it is possible to more effectively suppress a flow of the adhesive 5 onto the diaphragm 33 as compared to a case where the second inclination angle θ2 is smaller than the first inclination angle θ1.

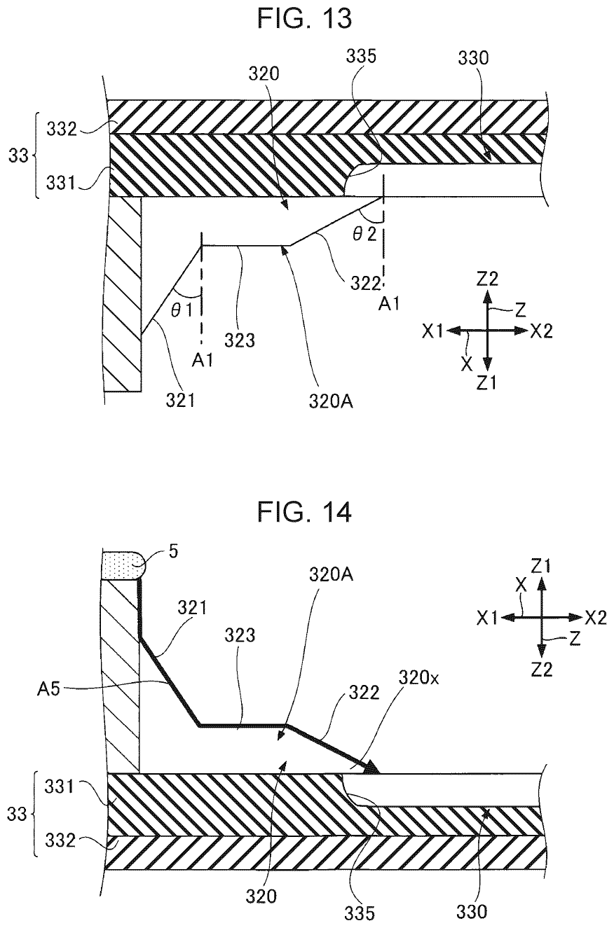

FIG. 14 is a view for describing a flow of the adhesive 5 in the second embodiment. As illustrated in FIG. 14, when the inclination of the second inclined surface 322 is gentler than that of the first inclined surface 321, the adhesive 5 flows as indicated by an arrow A5 and tends to stay on the second inclined surface 322. The adhesive 5 tends to stay at a distal end of the second inclined surface 322, that is, a distal end portion 320x of the inclined portion 320A. Therefore, it is possible to suppress the adhesive 5 from flowing onto the diaphragm 33.

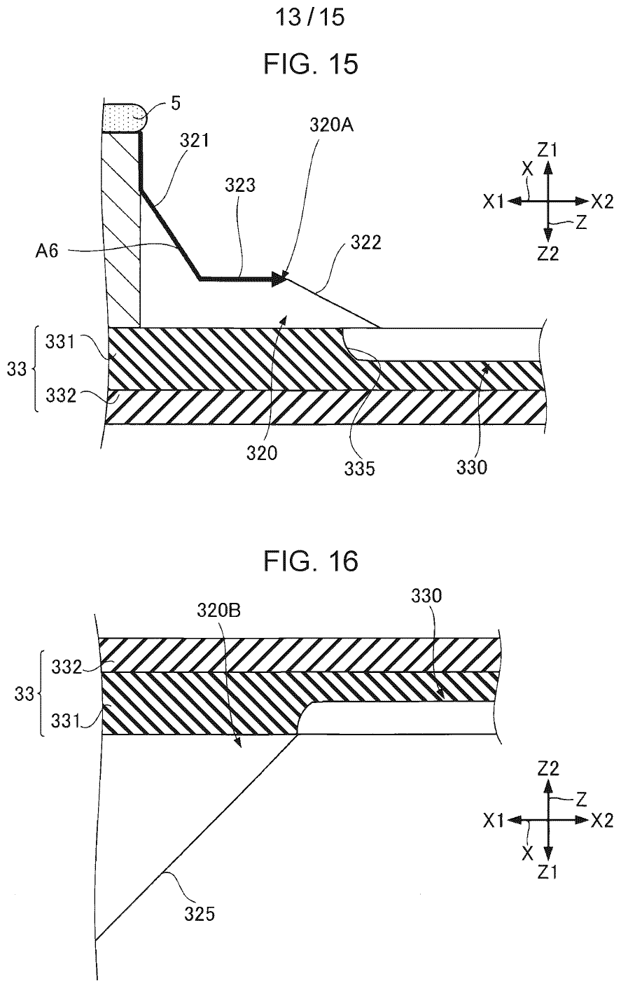

FIG. 15 is a view for describing another example of a flow of the adhesive 5 in the second embodiment. As illustrated in FIG. 15, the adhesive 5 may flow as indicated by an arrow A6 and stay on the horizontal surface 323. Since the horizontal surface 323 is horizontal, the adhesive 5 tends to stay on the horizontal surface 323. Therefore, the presence of the horizontal surface 323 makes it possible to suppress the adhesive 5 from flowing onto the diaphragm 33.

Although not illustrated, the adhesive 5 may stay on the first inclined surface 321. For example, the inclination of the first inclined surface 321 becomes gentler than that of the second inclined surface 322 by making the second inclination angle θ2 smaller than the first inclination angle θ1. In this case, accordingly, the adhesive 5 tends to stay on the first inclined surface 321.

The second inclination angle θ2 may be the same as the first inclination angle θ1. Also in this case, the inclined portion 320 has a plurality of inclined surfaces, and thus, it is possible to further suppress the adhesive 5 from flowing onto the diaphragm 33 as compared to a case where the inclined portion 320 has a single inclined surface.

### 3. Modified Examples

The embodiments exemplified above can be modified in various ways. Specific modified aspects that can be applied to the embodiments described above are described below by way of example. Two or more aspects arbitrarily selected from the following examples can be appropriately and compatibly combined.

An inclined surface 325 does not have to be a flat surface, and may include, for example, an uneven surface and a curved surface that is convex toward the diaphragm 33.

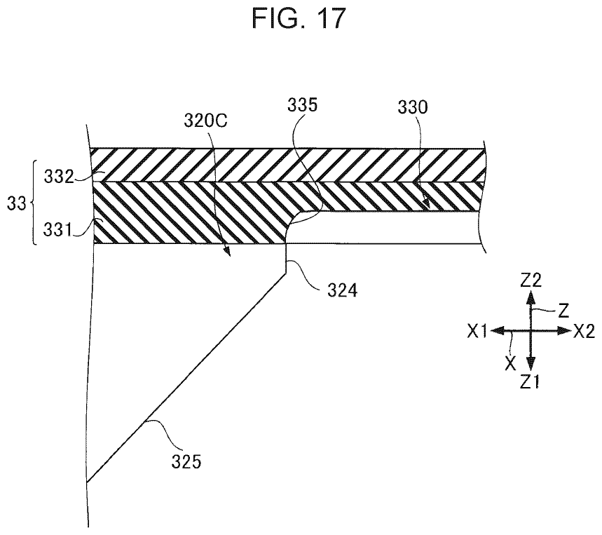

FIG. 16 is a view illustrating an inclined portion B of a modified example. In the example illustrated in FIG. 16, the inclined portion 320B does not overlap a recessed portion 330 of a diaphragm 33 in plan view. Therefore, the recessed portion 330 does not have a recess portion 335. Also in the example illustrated in FIG. 16, it is possible to suppress an adhesive 5 from flowing onto the diaphragm 33.

FIG. 17 is a view illustrating an inclined portion 320C of another modified example. In the example illustrated in FIG. 17, the inclined portion 320C does not overlap a recessed portion 330 of a diaphragm 33 in plan view. The inclined portion 320C is different from the inclined portion 320B in that a distal end is removed. Therefore, the inclined portion 320C has an inclined surface 325 and a vertical surface 324. The vertical surface 324 is positioned between the inclined surface 325 and the diaphragm 33 and couples the inclined surface 325 and the diaphragm 33. Also in the example illustrated in FIG. 17, it is possible to suppress an adhesive 5 from flowing onto the diaphragm 33.

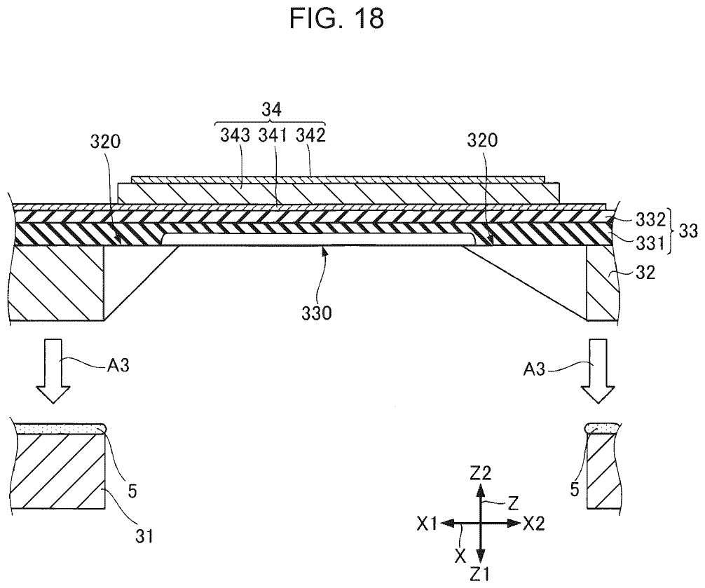

FIG. 18 is a view for describing bonding between the pressure chamber substrate 32 and the flow path forming substrate 31. In the example illustrated in FIG. 18, the adhesive 5 is applied onto the flow path forming substrate 31, and the pressure chamber substrate 32 is brought close to the flow path forming substrate 31 as indicated by an arrow A3, and the pressure chamber substrate 32 is disposed on the flow path forming substrate 31. By applying the adhesive 5 onto the flow path forming substrate 31, it is possible to further suppress the adhesive 5 from flowing onto the diaphragm 33, as compared to a case where the adhesive 5 is applied onto the pressure chamber substrate 32.

Further, the “liquid ejecting head” may be a circulation type head having a so-called circulation flow path.

The “image forming apparatus” can be adopted in various devices such as a facsimile machine and a copy machine in addition to a device dedicated to printing. The use of the image forming apparatus is not limited to printing. For example, the image forming apparatus that ejects a solution of a coloring material is used as a producing apparatus that forms a color filter of a display device such as a liquid crystal display panel. Further, the image forming apparatus that ejects a solution of a conductive material is used as a producing apparatus that forms a wiring or electrode of a wiring substrate. Further, the image forming apparatus that ejects a solution of organic matter related to a living body is used as, for example, a producing apparatus that produces a biochip.

Although the present disclosure has been described above based on the exemplary embodiments, the present disclosure is not limited to the above-described embodiments. Further, a configuration of each portion according to the present disclosure can be substituted with an appropriate configuration that can implement the same functions as the above-described embodiments, and any appropriate configuration can also be added.

What is claimed is:

1. A liquid ejecting head comprising:
a pressure chamber substrate forming a pressure chamber in which an liquid is stored;
a flow path forming substrate forming a flow path through which the liquid flows;
a pressure portion applying a pressure to the liquid in the pressure chamber; and
a diaphragm bonded to the pressure portion and vibrating with displacement of the pressure portion,
wherein the pressure chamber substrate is bonded to the flow path forming substrate with an adhesive and has inclined portions each having one or more inclined surfaces that are inclined with respect to a normal direction of a surface of the diaphragm in such a way that a width of the pressure chamber decreases toward the diaphragm.

2. The liquid ejecting head according to claim 1, wherein an inclination angle of the one or more inclined surfaces with respect to the normal direction is larger than 0 degrees and equal to or smaller than 45 degrees.

3. The liquid ejecting head according to claim 2, wherein
the one or more inclined surfaces are a plurality of inclined surfaces, and
the plurality of inclined surfaces have different inclination angles from each other.

4. The liquid ejecting head according to claim 3, wherein
the one or more inclined surfaces include a first inclined surface and a second inclined surface provided closer to the diaphragm than the first inclined surface in the normal direction, and
a second inclination angle is larger than a first inclination angle, the second inclination angle being an inclination angle of the second inclined surface with respect to the normal direction, and the first inclination angle being an inclination angle of the first inclined surface with respect to the normal direction.

5. The liquid ejecting head according to claim 1, wherein
the pressure chamber extends in a first direction intersecting the normal direction, and
the inclined portions are provided at both ends of the pressure chamber in the first direction.

6. The liquid ejecting head according to claim 1, wherein the inclined portion is provided at a portion of the pressure chamber substrate that is bonded to the diaphragm.

7. The liquid ejecting head according to claim 1, wherein
the diaphragm has a recess portion that is provided at a portion bonded to the pressure chamber substrate and is recessed in a first direction intersecting the normal direction, and
the inclined portion overlaps the recess portion in plan view of the diaphragm.

8. The liquid ejecting head according to claim 7, wherein the recess portion overlaps the inclined portion in a range of 50 nm or more and 1000 nm or less in plan view of the diaphragm.

9. The liquid ejecting head according to claim 1, wherein the inclined portion overlaps the pressure portion in plan view of the diaphragm.

10. An image forming apparatus comprising:
a liquid ejecting head that ejects a liquid,
wherein the liquid ejecting head is the liquid ejecting head according to claim 1.
